(19) United States
(12) Patent Application Publication
(10) Pub. No.: US 2011/0072851 A1
(43) Pub. Date: Mar. 31, 2011

(54) DIAMOND JEWELRY

(76) Inventors: Terrence Dashon Howard, New York, NY (US); Michael R. Monahan, Minneapolis, MN (US)

(21) Appl. No.: 12/567,400

(22) Filed: Sep. 25, 2009

(51) Int. Cl. A44C 17/02; A44C 17/04; A44C 9/00; A44C 7/00; B23P 5/00; A44C 27/00

(52) U.S. Cl. 63/3; 63/32; 63/26; 29/10; 29/896.412

(57) ABSTRACT

A diamond band made from solid diamond can be worn on a body part. Various pieces of jewelry are made from a diamond such as a plate of chemical vapor deposition formed diamond.

### FIELD

The present invention relates to the jewelry art, and specifically to jewelry made from a diamond.

### BACKGROUND

Diamonds have long been viewed as the symbol of eternal love and therefore associated with marriage through the use of diamond engagement rings and wedding rings.

The prior art is replete with jewelry that includes diamonds, such as wedding bands, engagement rings, and earrings. The settings to hold diamonds in place are widely varied. For example, it is known in the art to make a ring or band to encircle a finger from precious metals. A setting may be included at some point or points, on or embedded in the band. Precious stones, such as diamonds may be held in place by the settings.

### BRIEF DESCRIPTION OF THE DRAWINGS

FIG. 1 is a perspective view of a diamond band according to an example embodiment.

FIG. 2 is a front elevation view of the diamond band of FIG. 1.

FIG. 3 is a top view of the diamond band of FIG. 1.

FIG. 4 is side view of a portion of a diamond band having facets according to an example embodiment.

FIG. 5 is a top view of a diamond band having an embedded gemstone according to an example embodiment.

FIG. 6 is a top view of a diamond band having a gemstone in a setting according to an example embodiment.

FIG. 7A is a side elevation block representation of a diamond earring according to an example embodiment.

FIG. 7B is a side elevation block representation of an alternative diamond earring according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Various items of jewelry may be made from diamond. Some embodiments include a circular band made out of solid diamond. Further embodiments include multiple portions made out of solid diamond to form earrings, chains and other forms of jewelry.

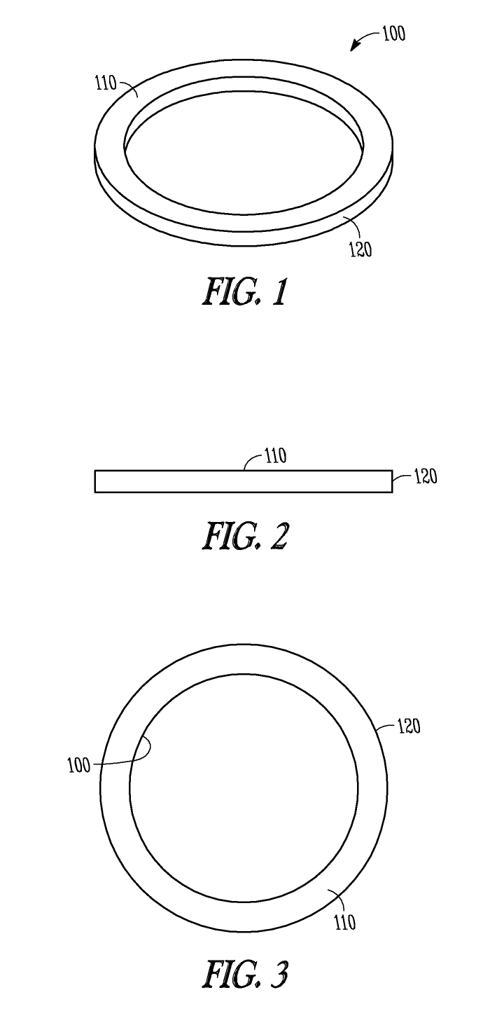

FIGS. 1, 2 and 3 show an example diamond band or ring 100. The band 100 is made of solid diamond in one embodiment, and may form a ring or bracelet. The band may be circular, oval, polygonal, or may be formed as a racetrack type pattern or may consist of various combinations of curved and polygonal portions. In some embodiments, the band may not be continuous, and may have a gap. The band may be worn on a body part, such as finger, wrist, neck, ankle, or other body part.

The term diamond is used to describe crystallized carbon. The present invention can be made of any of the commonly known types of diamond including the 4 types, known as type 1a, 1b, 2a, and 2b.

Diamond is comprised made mostly of carbon, and can be extremely pure. In almost all diamond material, however, there exists some portion of other elements, interspersed within the carbon as part of their crystal structure. These “impurities” are not what are commonly known as inclusions, visible to the naked eye or via magnification. These impurities are so subtle they may not even be visible under a very powerful microscope. Diamond material used to make the embodiments described herein are likely to contain some amount of other elements, or impurities.

The presence of other elements or combination of elements in diamond can give the diamond material a colored appearance. Various embodiments may be made out of diamond material having impurities such that it appears colored, including diamond material known as fancy colored diamond.

Diamond material is available from a number of sources. Diamond material may be mined from the earth or synthesized in a laboratory. Various embodiments may utilize diamond material from any source, as long as that material can be cut into a solid piece of diamond as described herein.

There are many diamond cutting techniques known in the art. Embodiments may be made utilizing any of the presently known cutting techniques. One of the methods used to create solid diamond jewelry include laser cutting solid diamond shapes out of a sheet of diamond made using a chemical vapor deposition process. Such a sheet of diamond may be formed as a single crystalline sheet using plasma assisted chemical vapor deposition. In further embodiments, the diamond may be formed by high pressure high temperature methods.

In one embodiment, the band 100 is substantially circular in shape, with straight sides. It may be cut from a sheet of diamond that is polished flat on both sides of the sheet, The sides of the sheet form the edges of the band 100 as indicated at 110. The inner edge 115 of the band 100 may be smooth in one embodiment, or may include a series of straight cuts by laser or other cutting device. In one embodiment, a large number of straight cuts may be used to form the inner edge of the ring to avoid potential discomfort of a wearer. In addition, a large number of cuts, such as 500 or more, may appear smooth or perfectly circular to a casual wearer. The inner edge defines a band or ring size, which may be customized to individual wearers in one embodiment.

An outer edge 120 of the band 100 may also be smooth, or consistent of a series of straight cuts similar to the inner edge 115. In further embodiments, such as shown in a partial view of a band in FIG. 4, an outer edge and sides of the band may include one or more facets 410 cut into the band to enhance the amount of light reflected by the band and give the ring the appearance of a cut gemstone. The facets may be formed along some portion or the entirety of the piece of diamond material.

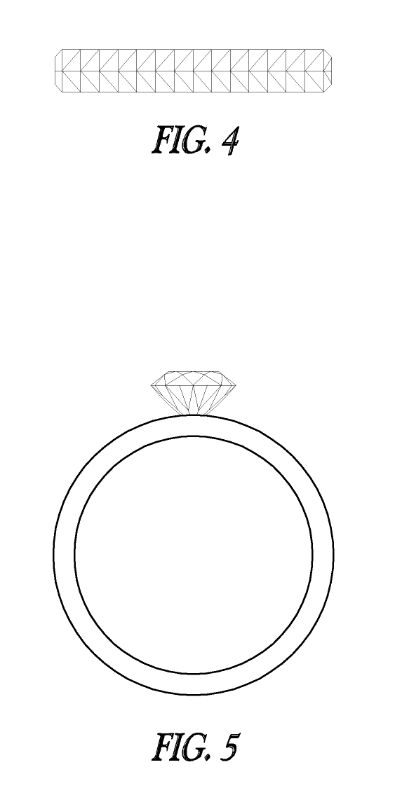

In one embodiment as shown in FIG. 5, a diamond band 500 includes, as an integral component, a portion that appears to be a separate gemstone 510. The gemstone may be formed to appear to be part of the band, extending from the band to feature the gemstone. The gemstone 510 may have any type of cut desired, such as round brilliant, having a base that appears embedded into the band.

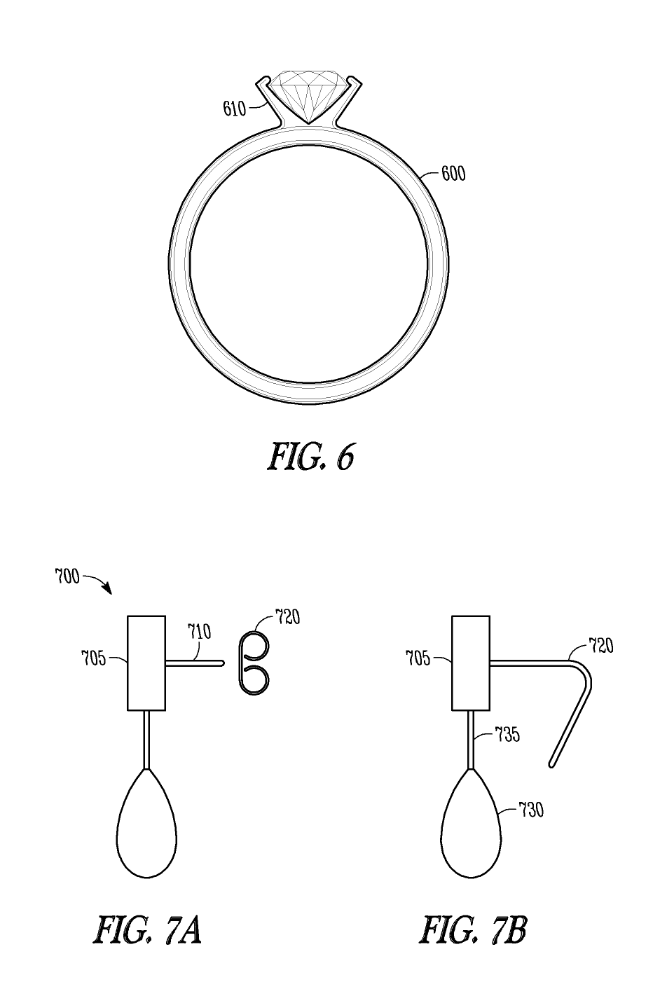

In further embodiment in FIG. 6, diamond material may be cut to include a setting 610 on a band 600, to appear as a traditional diamond solitaire engagement ring. The ring 600 appears as a band with a gemstone setting at some point on the band. Many different settings may be cut from the diamond material in various embodiments. The diamond material may be rotated to different angles to accomplish the cuts to form such settings and gemstone combinations. Rings or bands incorporating a gemstone may be smooth or faceted in various embodiments. As shown in FIG. 6, the band has been cut and/or polished to give it a rounded appearance line a metal ring.

FIG. 7A is a perspective view of a diamond earring 700 according to an example embodiment. The diamond earring 700 in one embodiment is formed entirely of diamond. One example earring 700 includes a first portion 705 having a post 710 for insertion into a hole in a body part of a wearer, such as an ear or other portions of the body. A separate clip 720 formed of any desired material may be used to fasten the earring 700 via the post 710. In a further embodiment illustrated in FIG. 7B, the post may be curved to form a loop 720 such that the earring may be held in place by gravity. The first portion 705 may be formed in the shape of a gemstone in one embodiment, and may have a further a second portion 730 formed integral with the first portion 705. The second portion 730 may be a portion with a distinct design separate from the first portion, or may be of a similar design, but appearing separate from the first portion such that a viewer would not consider them as forming a single gemstone. In one embodiment, the first and second portions may be joined by a rod 735 or other structure between the two portions. A diamond chain may be used as a connecting portion in one embodiment. The rod itself may be considered a portion or joining portion that joins two main portions together. In one embodiment, the portions may appear as separate gemstones or separate design features. In further embodiments, a separate non-diamond, such as metal or plastic clasp for attaching to an ear may be attached to the earring.

Many further portions may be included, providing the ability to from an infinite number of different shapes of earrings, or other items of jewelry. In some embodiments, portions may be formed of interlocking loops to provide a chain or necklace appearance, and may be worn by a person. The loops may be fixed in relation to each other, or may be separate loops that are moveable relative to each other. The loops may be formed from a plate of diamond, rotating the diamond to form alternate loops, and freeing the loops from each other via one or more laser cuts from various angles. In further embodiments, selected portions of jewelry, such as posts in an earring, may be formed of other material if desired.

In one embodiment, a portion may be formed in the shape of an animal or insect, or other desired subject, including abstract art. As indicated above, the possibilities for design of a portion or connected portions may be infinite. In one embodiment, the set of designs may be limited by the size and shape of the starting material. When a plate of chemical vapor deposition diamond is used as a starting material, it is a block of diamond from which material is removed to form the jewelry. In one embodiment, if a ring with gemstone feature is being made, the ring will likely be cut primarily from the top of the plate, with an outline of the gemstone feature also being first cut from the top of the plate. In such an embodiment, the gemstone may not be larger than the thickness of the plate. Further, it will have a crystalline orientation that is defined by the crystalline orientation of the plate.

When a plate of single crystalline chemical vapor deposition diamond is used to form a band or other multi-component jewelry, the components will all have the same crystalline orientation, and may be perfectly matched in terms of color and clarity. Since such plates may be made with various colors, such as pink, blue or yellow, in addition to colorless to near colorless, the matching of the color among the components of the jewelry may provide for striking, all diamond, combinations formed into a wide array of different solid diamond items of jewelry.

This invention is intended to cover all changes and modifications of the example embodiments described herein which do not constitute departures from the scope of the claims.

What is claimed is:

1. A band made of solid diamond adapted to encircle a part of a person.

2. The band of claim 1 and having at least one separate precious stone attached at some point on the band.

3. The band of claim 1 has and having a precious stone embedded in the solid diamond band.

4. The band of claim 1 having a crown which includes a setting for mounting at least one gemstone.

5. The band of claim 1 containing a gap so that that the band does not make a complete band.

6. The band of claim 1 wherein the diamond is colored.

7. The band of claim 1 wherein the band is oval shaped.

8. The band of claim 1 wherein the shape of the band contains polygonal sections.

9. A jewelry article in the shape of a circle, oval, or polygon made of solid diamond.

10. The jewelry article of claim 9 wherein the solid diamond is a fancy colored diamond.

11. The jewelry article of claim 9 having a post so as to be worn on the ear.

12. Apparatus comprising:
a first component;
a second component coupled to the first component, wherein the components are distinct items of jewelry formed of diamond.

13. The apparatus of claim 12 wherein the components comprise single crystalline diamond having the same crystal orientation.

14. The apparatus of claim 13 wherein the components have the same color and clarity.

15. The apparatus of claim 12 wherein there are at least two components coupled by a further component.

16. A method comprising:
cutting a band of diamond from a plate of single crystalline chemical vapor deposition formed diamond.

17. The method of claim 16 wherein the band is cut by use of a laser.

18. The method of claim 16 and further comprising forming multiple facets on the circular band of diamond.

19. The method of claim 16 and further comprising cutting a featured gemstone as an integral part of the band from the plate of diamond.

20. A method comprising:
forming a first component from a plate of diamond; and
forming a second component integrally coupled to the first component from the plate of diamond.
